(19) United States
(12) Patent Application Publication
(10) Pub. No.: US 2005/0060228 A1
(43) Pub. Date: Mar. 17, 2005

(54) Method and system for offering a money-back guarantee in a network-based marketplace

(76) Inventor: Katherine Woo, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/664,289

(22) Filed: Sep. 16, 2003

(51) Int. Cl. G06F 17/60

(52) U.S. Cl. 705/14; 705/39

(57) ABSTRACT

A method and system for providing a money-back guarantee for a transaction in a network-based marketplace. The system provides an interface for a buyer to file a reimbursement request against the money-back guarantee for an eligible transaction. The system upon receiving notification over a network indicating the reimbursement request verifies the reimbursement request is eligible for the money-back guarantee. Once verified, the system electronically reimburses the buyer a predetermined amount associated with the eligible transaction and the money-back guarantee.

### FIELD OF THE INVENTION

The present invention relates generally to the field of money-back guarantees and, more specifically to providing a money-back guarantee in a network-based marketplace.

### BACKGROUND OF THE INVENTION

Many retail businesses and manufactures offer some type of money-back guarantee based on customer satisfaction. Generally, a manufacture's guarantee takes the form of a product warranty that sometimes is supplemented by purchasing an extended warranty from a third party. For sellers of products or retail businesses, the money-back guarantee is offered to instill confidence in the buyer that the seller stands behind the products they sell and is willing to refund the purchase price upon reasonable demand.

However, for the network-based marketplace, such as an online auction facility, buyers simply have to trust the seller's representation the product is not defective and will be timely shipped. Further, once received, the seller takes the product “as is” and generally has no recourse against a seller. This apparent lack of recourse truly inhibits a buyer's confidence to engage in any type of auction or non-auction network transaction, particularly for a buyer's first network transaction. Consequently, the seller and the network market place are adversely impacted by a buyer's lack of confidence. The provision of a guarantee on an electronic trading platform presents a number of technical challenges that are not faced in tradition sales channels.

### SUMMARY OF THE INVENTION

A method of providing a money-back guarantee for a transaction in a network-based marketplace, the method including receiving, over a network, a reimbursement request against the money-back guarantee for an eligible transaction, receiving notification over a network indicating the reimbursement request responsive to receiving the notification, verifying the reimbursement request is eligible for the money-back guarantee, and electronically reimbursing the buyer a predetermined amount associated with the eligible transaction and the money-back guarantee.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a system to offer a money-back guarantee in a network-based marketplace, according to an exemplary embodiment of the present invention;

FIG. 2 is a block diagram illustrating software and hardware components of the network-based marketplace machine, the client machine, and the payment machine, according to an exemplary embodiment of the present invention;

FIG. 3 is a block diagram illustrating hardware components of the payment machine utilized by the system, according to an exemplary embodiment of the present invention;

FIG. 4 is a block diagram illustrating an exemplary embodiment of a seller verification module operating on the page server of the network-based marketplace machine;

FIG. 5 is a block diagram illustrating an exemplary embodiment of a buyer interface module operating on the page server of the payment machine;

FIG. 6 is a block diagram illustrating exemplary embodiment of a transaction verification module and a transaction module, each operating on the guarantee server of the payment machine;

FIG. 7 is a block diagram illustrating an exemplary embodiment of a reimbursement request module, a reimbursement verification module and a disbursement module;

FIG. 8 is a database diagram illustrating an exemplary database maintained and accessed via a database engine server that supports the network-based marketplace machine;

FIG. 9 is a database diagram illustrating, according to an exemplary embodiment of the present invention, selected fields from the user table, the purchase history table and the listing table as embodied on the database at the network-based marketplace machine;

FIG. 10 is a database diagram illustrating, according to an exemplary embodiment of the present invention, database maintained and accessed via a database engine server that supports the reimbursement engine on the payment machine;

FIG. 11 is a database diagram illustrating selected fields from the payment machine user table, the transaction history table, the money-back guarantee stats table, and the case management table as embodied on the database at the payment machine;

FIG. 12 is a flowchart illustrating a method, according to an exemplary embodiment of the present invention, wherein a seller on a client machine is offered by a network-based marketplace machine the option to opt in or out of the money-back guarantee program;

FIG. 13 is an interactive flowchart illustrating a method, according to an exemplary embodiment of the present invention, wherein a buyer on client machine is offered by the payment machine the option to purchase the money-back guarantee for the item being purchased;

FIG. 14 is an interactive flowchart illustrating a method, according to an exemplary embodiment of the present invention, wherein a buyer at a client machine initiates a reimbursement request for a transaction at payment machine;

FIG. 15 illustrates, according to an exemplary embodiment of the present invention, the opt in page that includes the text that further details the money-back guarantee program and supplies a check box for the seller to opt in to the money-back guarantee program;

FIG. 16 is an example, according to an exemplary embodiment of the present invention, of a transaction confirmation page including an option to purchase the money-back guarantee;

FIG. 17 illustrates, according to an exemplary embodiment of the present invention, a money-back guarantee reimbursement request form;

FIG. 18 illustrates a diagrammatic representation of machine in the exemplary form of a computer system wherein a set of instructions can be executed to cause the machine to perform any one or more of the methodologies discussed herein.

### DETAILED DESCRIPTION

A method and system to offer a money-back guarantee in a network-based marketplace, are described. In the following description, for purposes of explanation, numerous specific details are set forth in order to provide a thorough understanding of the present invention. It will be evident, however, to one skilled in the art that the present invention may be practiced without these specific details.

In general, embodiments described below feature a reimbursement engine that verifies eligibility for reimbursement to a buyer based on a money-back guarantee offered to the buyer by the network-based marketplace. Further, the disbursement engine processes the reimbursement request from the buyer and electronically disburses a reimbursement to the buyer for defective (or otherwise problematic) item(s) associated with the eligible transaction. An eligible transaction is predetermined by the network marketplace or its associated payment system and can be, for example, associated with such terms or conditions, such as total cost of transaction or time between transaction and reimbursement request. A defective item is predefined by the network marketplace and can include, but is not limited to, a defective item, an item that the buyer does not receive, or an unwanted transaction associated with the item.

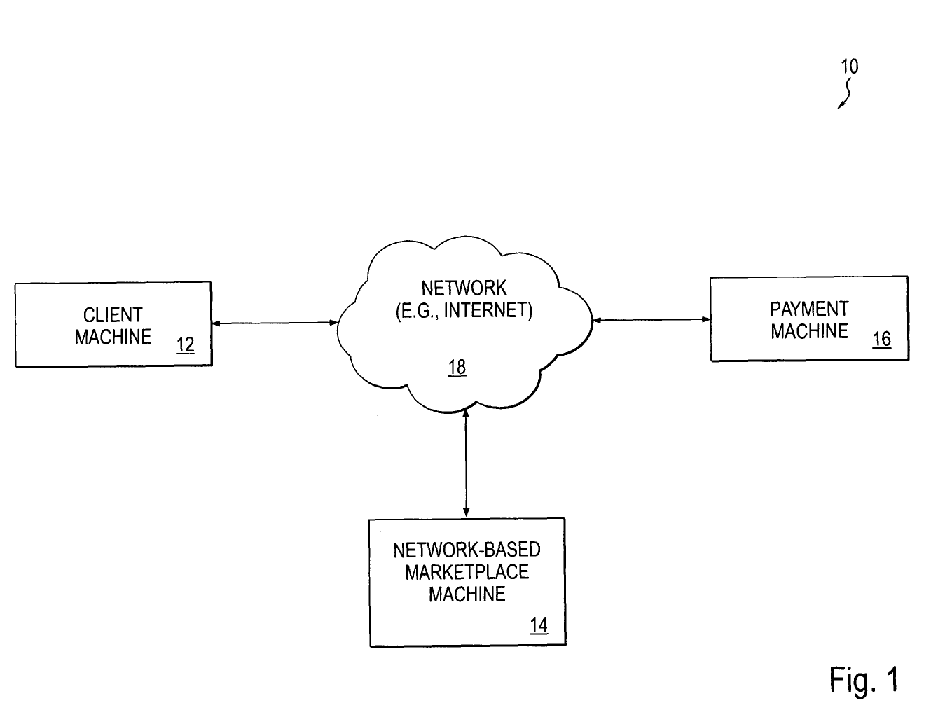

FIG. 1 is a block diagram illustrating a system 10 to offer a money-back guarantee in a network-based marketplace, according to an exemplary embodiment of the present invention. The system 10 includes a client machine 12, a network-based marketplace machine 14, and a payment machine 16 that communicate via a network 18. The network 18 may be embodied as the Internet, a LAN (local area network), a WAN (wide area network), PSTN (public switched telephone network), Frame Relay, ATM (asynchronous transfer mode), satellite communications, wireless communications, combinations thereof, or any other network equipment or protocol that enables electronic communication between the above described network entities.

The client machine 12 enables the client to access services that are provided by the network-based marketplace machine 14 and the payment machine 16.

The network-based marketplace machine 14 provides online marketplace services that enable sellers and buyers to transact items and services. For example, a buyer that submits a winning bid in an auction or executes a purchase to complete a sale may acquire goods and/or services from the seller. The buyer may also choose, in another embodiment, to immediately buy the listing from the seller for a fixed price. In one embodiment the network-based marketplace machine 14 may be embodied as “eBay The World's Online Marketplace” ™ created by Ebay of San Jose, Calif. In another embodiment, the network-based marketplace machine 14 may be embodied as an individual seller's e-commerce website.

The payment machine 16 provides payment services that enable a user that utilizes e-mail electronically to send and receive payments over the network 18. The payment machine 16 may also provide a seller with an option to offer a money-back guarantee for the seller's eligible transactions. In another embodiment, the network-based marketplace machine 14 may provide the seller with the option to offer the money-back guarantee for the seller's eligible transactions. In addition, the buyer can elect to purchase the money-back guarantee for the purchased item associated with the eligible transaction and subsequently submit a reimbursement request for a defective item or unwanted transaction. Based upon the affirmation of the transaction's eligibility, the buyer can be electronically reimbursed for at least a portion of the transaction amount. In one embodiment, the transaction amount reimbursed by the payment machine 16 may be the total transaction amount associated with the sale less the cost of the money-back guarantee. The payment machine 16, for example, may be embodied as the Paypal™ Payment Service operated by PayPal of Mountain View, Calif.

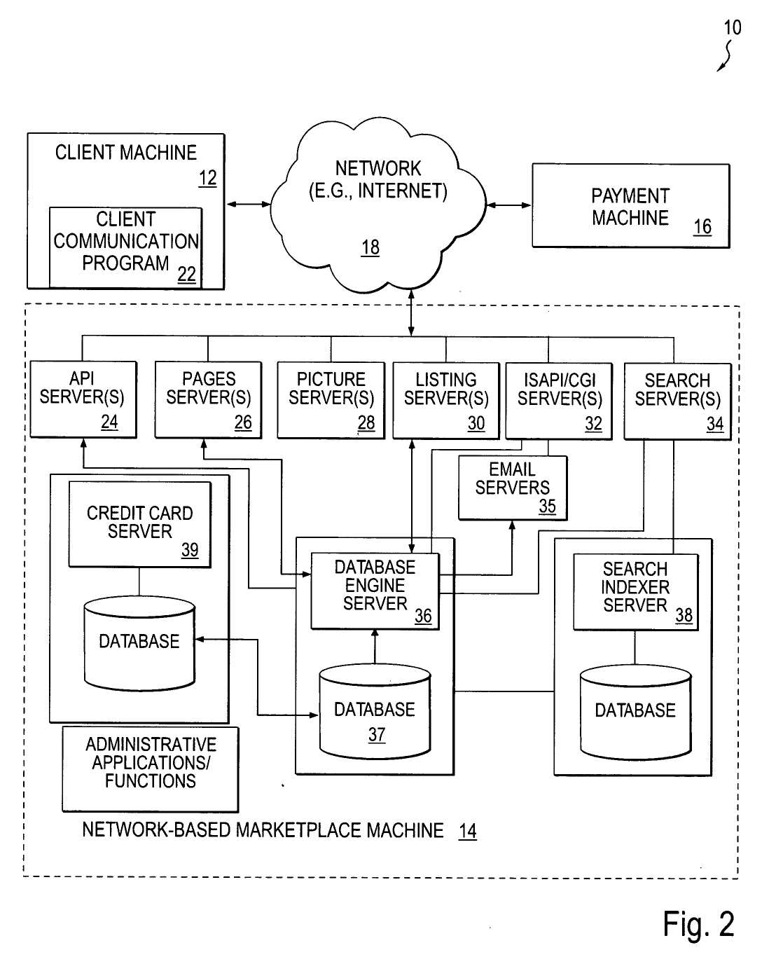

FIG. 2 is a block diagram illustrating software and hardware components of the network-based marketplace machine 14, the client machine 12, and the payment machine 16, according to an exemplary embodiment of the present invention.

In addition to other software components that are not illustrated, the client machine 12 includes a client communication program 22. The client communication program 22 enables a user to display web pages or e-mails that are loaded from server computers. The client communication program 22 may be embodied as a browser (e.g., the Microsoft Internet Explorer browser developed by Microsoft™ Corporation of Richmond, Wash. or Navigator™0 browser developed by Netscape of Mountain View, Calif.). The client communication program 22 executes under an operating system (e.g., Microsoft™ Windows developed by Microsoft™ Corporation or Mac OS X developed by Apple Computers of Cupertino, Calif.). The client communication program 22 may also be embodied as a mail client (e.g., the Microsoft Outlook personal information manager developed by Microsoft™ Corporation of Richmond, Wash. or Lotus Notes™ developed by the Lotus Notes Development Corporation.

The network-based marketplace machine 14 includes one or more of a number of types of front-end servers, namely communications servers in the exemplary form of an application program interface (API) servers 24, page servers 26 that deliver web pages (e.g., markup language documents), picture servers 28 that dynamically deliver images to be displayed within Web pages, listing servers 30, processing servers in the exemplary form of CGI (common gateway interface) or ISAPI (internet server application program interface) servers 32 that provide an intelligent interface to back-end servers, and search servers 34 that handle search requests to the network-based marketplace machine 14. The e-mail servers 35 provide, inter alia, automated e-mail communications to users of the network-based marketplace machine 14.

The back-end servers include a database engine server 36, a search index server 38 and a credit card database server 39, each of which maintains and facilitates access to a respective database such as, database 37 under the database engine server 36.

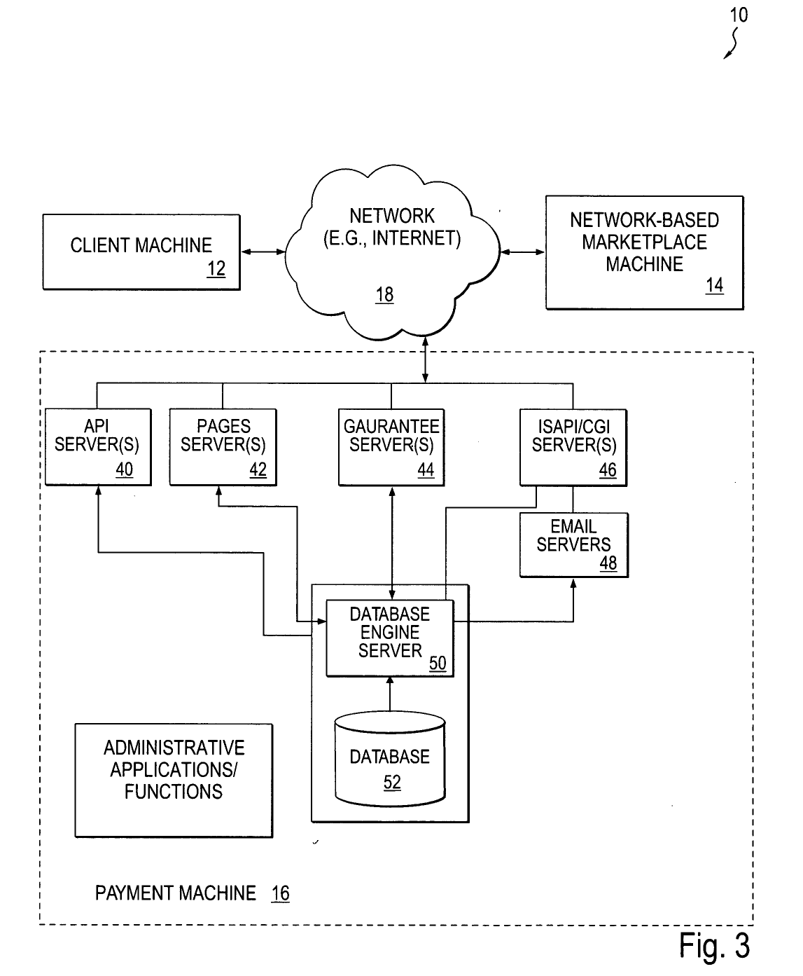

FIG. 3 is a block diagram illustrating hardware components of the payment machine 16 utilized by the system 10, according to an exemplary embodiment of the present invention.

The payment machine 16 includes one or more of a number of types of front-end servers, namely communications servers in the exemplary form of an API (application program interface) servers 40 and page servers 42 that deliver web pages (e.g., markup language documents), transaction processing and eligibility servers in the exemplarily form of guarantee servers 44 that process money-back guarantee eligibility and reimbursement requests, and processing servers in the exemplary form of CGI (or ISAPI) servers 46 that provide an intelligent interface to back-end servers. The e-mail servers 48 provide, inter alia, automated e-mail communications to users of the payment machine 16. The back-end servers include database engine server 50 that maintains and facilitates access to database 52.

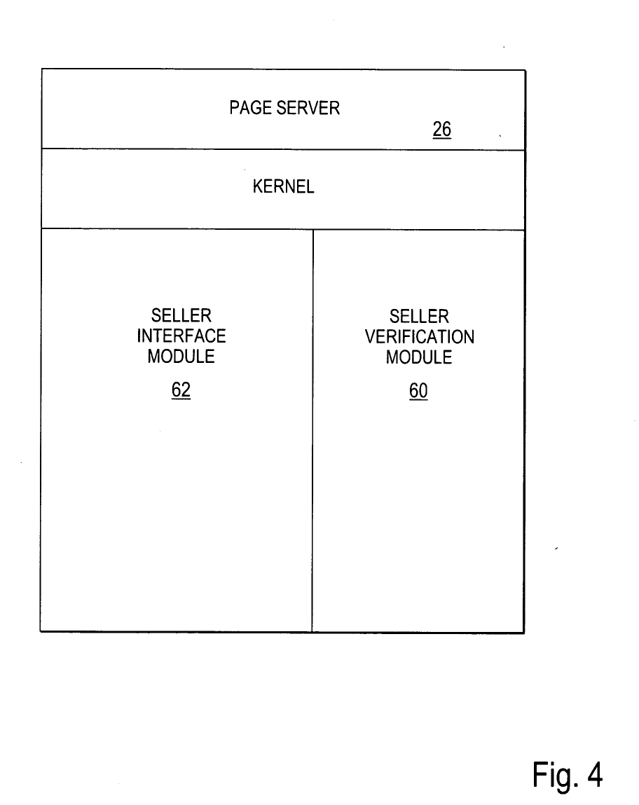

FIG. 4 is a block diagram illustrating an exemplary embodiment of a seller verification module 60 operating on the page server 26 of the network-based marketplace machine 14. The seller verification module 60 executes under kernel operating software to scan database 37 coupled to the database engine server 36 for sellers that are eligible for opting into the money-back guarantee program.

Also illustrated in FIG. 4 is an exemplary seller interface module 62 operating on page server 26 of the network-based marketplace machine 14. The seller interface module 62 executes under kernel operating software to provide a page for the seller to opt into the money-back guarantee program for all eligible transactions. In an exemplary embodiment and eligible transaction is determined by the payment machine, for example, an eligible transaction can be a transaction that has a total value of under $1,000.00 USD and has been transacted within 30 days of receipt of a reimbursement request. In another embodiment, the network-based marketplace machine may determine what is an eligible transaction.

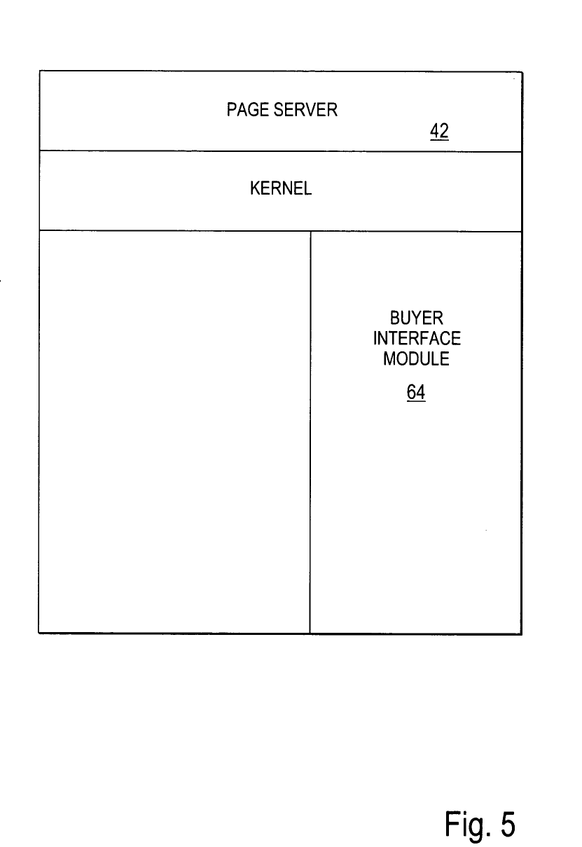

FIG. 5 is a block diagram illustrating an exemplary embodiment of a buyer interface module 64 operating on the page server 42 of the payment machine 16. The user interface module 64 executes under kernel operating software to provide a buyer with a page to select the money-back guarantee associated with an eligible transaction.

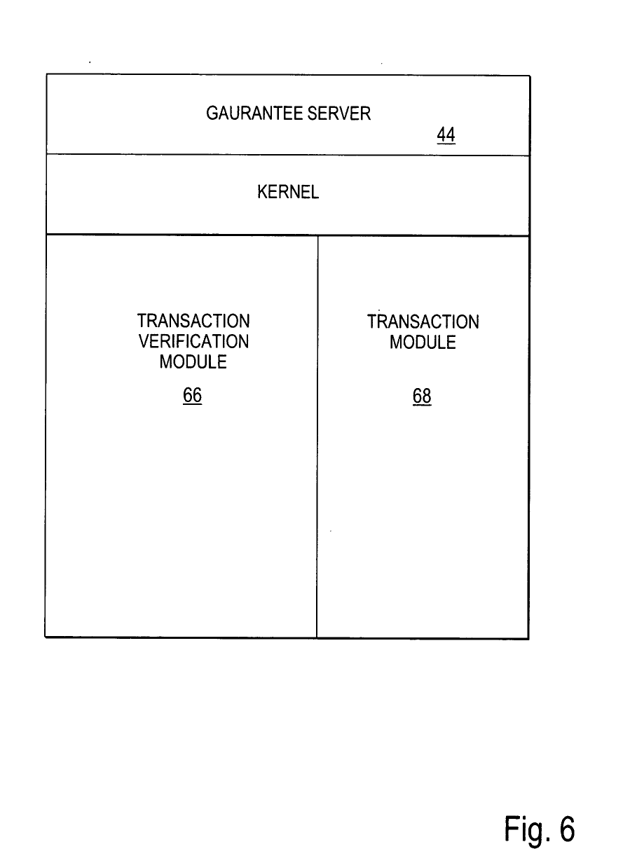

FIG. 6 is a block diagram illustrating exemplary embodiment of a transaction verification module 66 and a transaction module 68, each operating on the guarantee server 44 of the payment machine 16. The transaction verification module 66 executes under kernel operating software to determine whether the transaction is eligible for offering the buyer the money-back guarantee.

The transaction verification module 66 can also be used to verify that the reimbursement request received from the buyer is associated with an eligible transaction and the buyer elected to purchase the money-back guarantee.

The transaction module 68 executes under kernel operating software to calculate a fee that is presented to the buyer when the buyer interface module 64 offers the money-back guarantee associated with the eligible transaction to the buyer. For example, in one embodiment, the fee calculation can be based on a percentage of the transaction cost plus a flat fee and is in addition to the total transaction cost.

In addition, the transaction module 68 can be utilized to collect the transaction cost plus the fees associated with the money-back guarantee if selected by the buyer and to generate a transaction number upon receiving the buyer's payment.

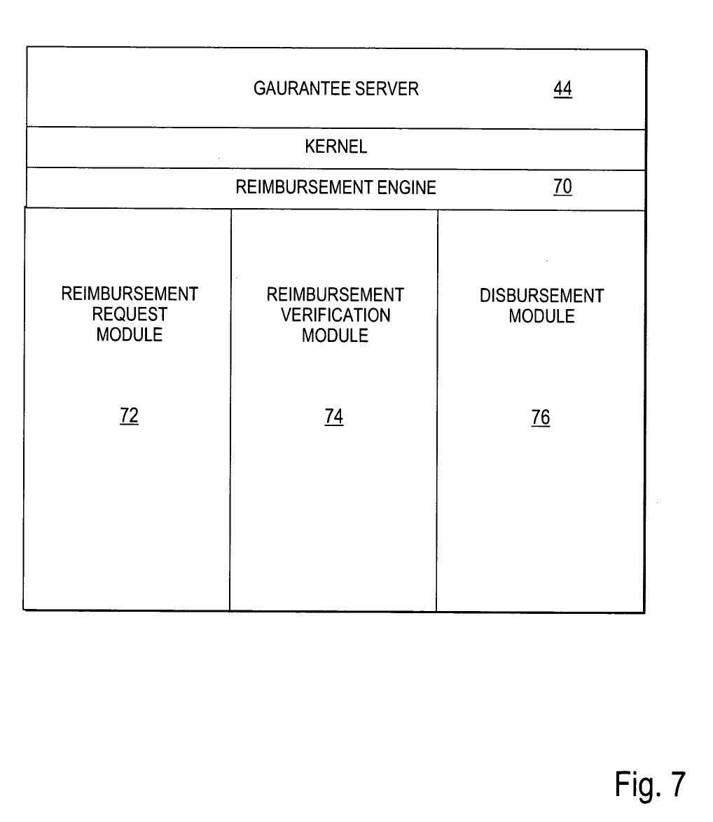

FIG. 7 is a block diagram illustrating an exemplary embodiment of a reimbursement request module 72, a reimbursement verification module 74 and a disbursement module 76. These modules execute on payment machine 16 on the guarantee server 44 under the reimbursement engine 70 operating under kernel software.

The reimbursement request module 72.is utilized to provide an interface for a buyer to file a reimbursement request based upon a transaction, wherein the buyer elected and purchased a money-back guarantee for an item associated with the transaction. In one embodiment, the interface for the reimbursement request is a web form, wherein the buyer accordingly fills out and submits the completed form over the network to the payment machine 16 and more specifically, to the reimbursement request module 72. The web form can include such fields as, “category of item” and/or “reason for request.” For example, “reason for request” can include defective item, unwanted item, or item not received.

The reimbursement verification module 74 verifies the transaction indicated in the reimbursement request is a transaction eligible for the money-back guarantee. In one embodiment, verification can include verifying the transaction identification matches an eligible transaction, the requestor is the buyer associated with the transaction, and the buyer selected and purchased the money-back guarantee.

The disbursement module 76, in response to receiving verification a money-back guarantee is to be honored, is utilized to electronically reimburse the buyer a predetermined amount associated with the eligible transaction. For example, in an exemplary embodiment, the predetermined amount can be determined by the transaction cost associated with the item purchased less any fees associated with purchasing the money-back guarantee. In one embodiment, the electronic reimbursement can include reverse debiting the buyer's credit card. In other embodiments, the reimbursement is electronically transferred to a buyer account associated with the payment machine or a check is mailed to the buyer.

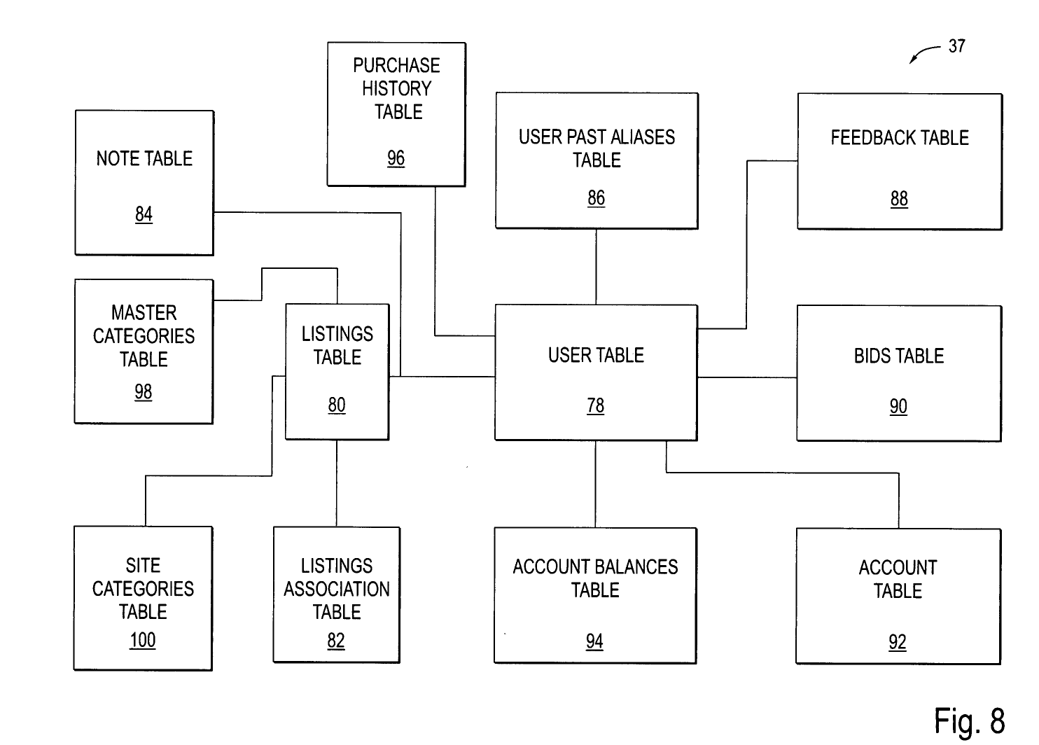

FIG. 8 is a database diagram illustrating an exemplary database 37 maintained and accessed via a database engine server 36 that supports the network-based marketplace machine 14. The database 37 may, in one embodiment, be implemented as a relational database, and includes a number of tables having entries, or records, that are linked by indices and keys. In an alternative embodiment, the database 37 may be implemented as a collection of objects in an object oriented database.

The database 37 includes a user table 78 that contains a record for each user of the network-based marketplace machine 14. The user may operate as a seller, buyer, or both, within the network-based marketplace machine 14. The database 37 also includes listings table 80 that may be linked to the user table 78 and a listing association table 82. A user record in the user table 78 may be linked to multiple items that are being, or have been, transacted via the network based-marketplace machine 14.

The database 40 also includes a note table 84 populated with note records that may be linked to one or more listing records within the listings table 80 and/or to one or more user records within the user table 78. Each note record within the note table 84 may include, inter alia, a comment, description, history or other information pertaining to an item being auctioned via the network-based marketplace machine 14, or to a user of the network-based marketplace machine 14.

The number of other tables are also shown to be linked to the user table 78, namely a user past aliases table 86, a feedback table 88, a bids table 90, an account table 92, an account balances table 94 and a purchase history table 96.

The masters categories table 98 stores records for listing categories presented across multiple views (or presentations) of list categories via regional or community sites presented by the network-based marketplace machine 14. A site categories table 100 stores records indicating which item categories are to be presented for respective regional or community sites (e.g., a country, region or city specific site) presented by the network-based marketplace machine 14.

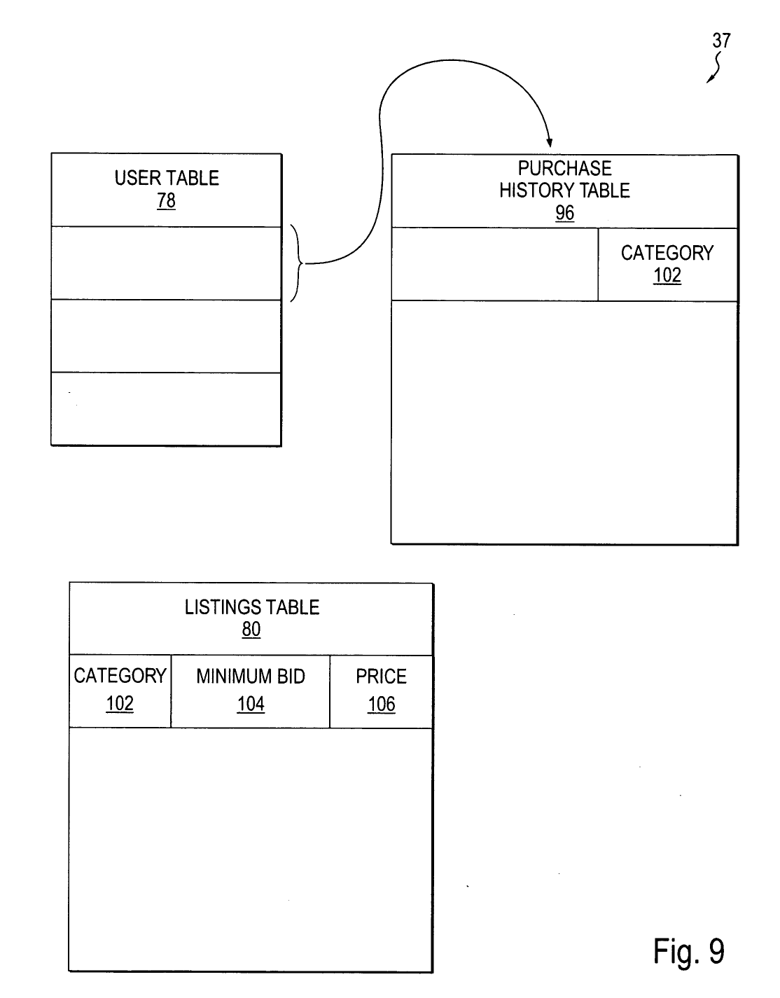

FIG. 9 is a database diagram illustrating, according to an exemplary embodiment of the present invention, selected fields from the user table 78, the purchase history table 96 and the listing table 80 as embodied on the database 37 at the network-based marketplace machine 14.

The user table 78, according to an exemplary embodiment of the present invention, can include entries that identify a user by a user's legal name or by a user's chosen name, and further include a link to the purchase history table 96. The purchase history table 96 includes records that chronicle the purchasing history of the associated user. Each record represents a purchase that is further described by a category 102 that is descriptive of the item or service purchased by the user.

The listings table 80 includes an entry for each listing presented on the network-based marketplace machine 14. A seller enters a listing to offer an item or service for auction or purchase on the network-based marketplace machine 14. Each listing may include, among other fields, the category 102, a minimum bid 104 that is initialized to enable an auction, and a price 106 that is initialized to enable a purchase.

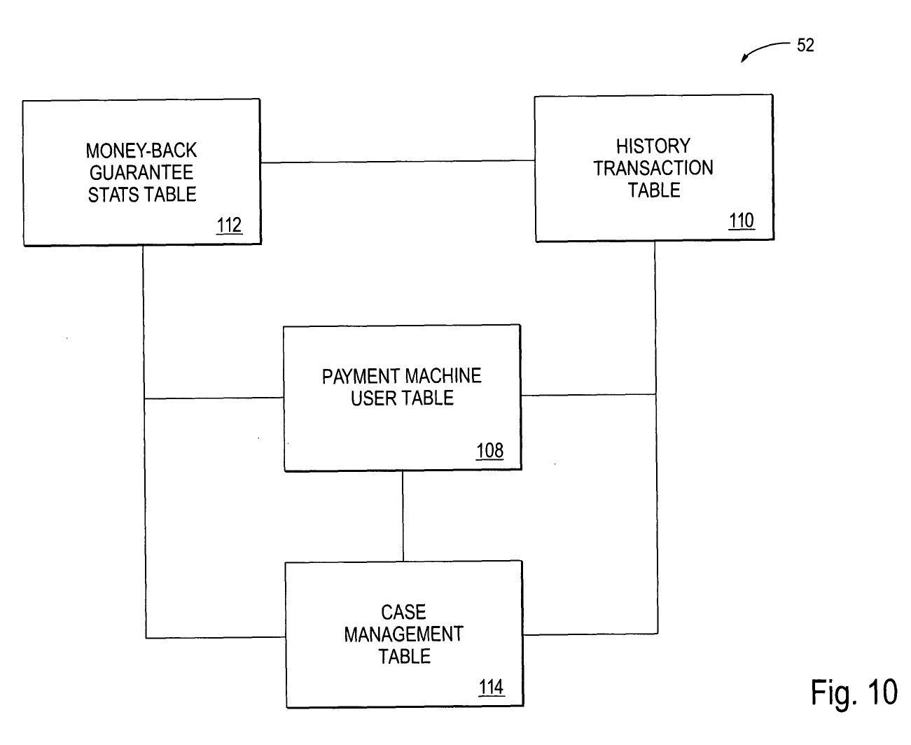

FIG. 10 is a database diagram illustrating, according to an exemplary embodiment of the present invention, database 52 maintained and accessed via a database engine server 50 that supports the reimbursement engine 70 on the payment machine 16. The database can, according to an exemplary embodiment of the present invention, be implemented as a relational database, and includes a number of tables having entries or records, that are linked by indices and keys. In an alternative embodiment, the database 52 may be implemented as a collection of objects in an object-oriented database.

The database 52 includes a payment machine user table 108, which contains a record for each user of the payment machine 16. A user may operate as a payer or payee (buyer or seller) or both within the payment machine 16. Each user on the payment machine 16 is linked via the user table 108 to a transaction history table 110, a money-back guarantee table 112, and a case management table 114. As illustrated, these table are also linked to each other. In one embodiment, these tables may be cross-referenced or otherwise accessed for use by the network-based marketplace machine 14. In another embodiment, one or all of these tables may be located on database 37 of the network-based marketplace machine 14 and accessed by the payment machine 16.

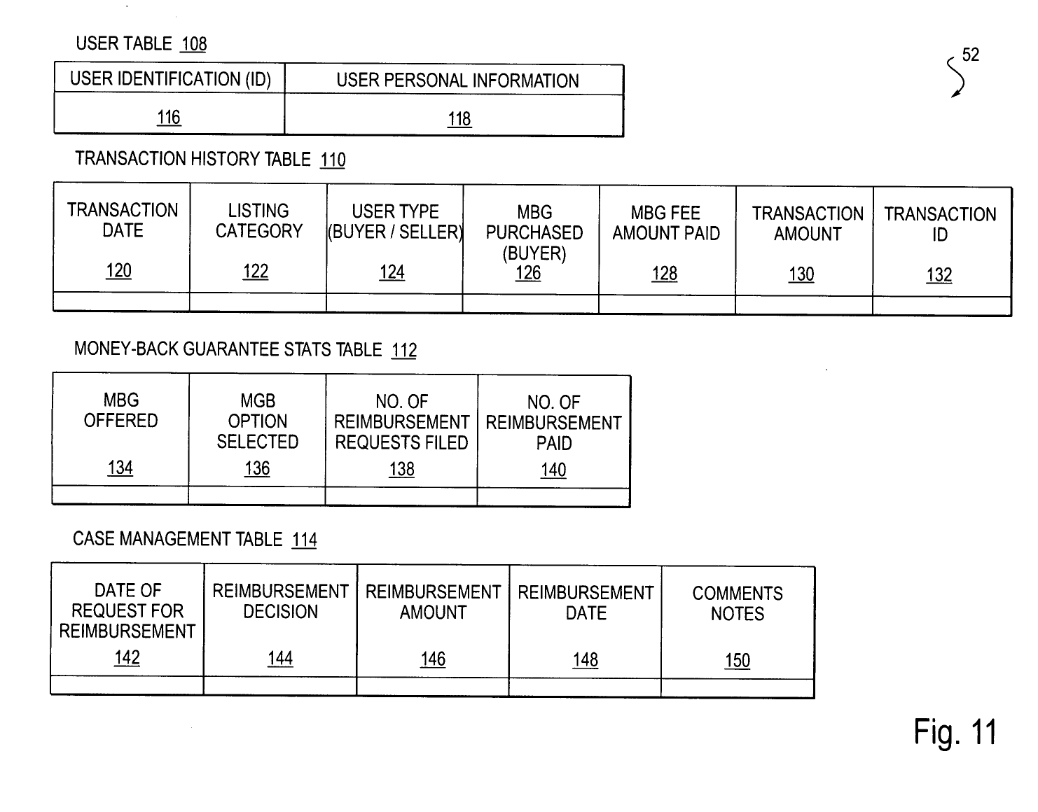

FIG. 11 is a database diagram illustrating selected fields from the payment machine user table 108, the transaction history table 110, the money-back guarantee stats table 112, and the case management table 114 as embodied on the database 52 at the payment machine 16. As discussed with reference to FIG. 10, the user table 108 is linked to the transaction history table 110, the money-back guarantee stats table 112, and the case management table 114.

The user table 108, according to an exemplary embodiment of the present invention, includes records that contain a user's identification (ID) 116 and personal information 118. The user ID record 116 can be a number, a letter, symbol or any combination thereof. The personal information record 118 can include such entries as, email address, shipping address, and a user reputation score associated with a user's payment activity.

The transaction history table 110 includes records that chronicle the purchasing history of the associated user. Each record represents a purchase that is further described by a transaction date 120, a listing category 122, a user type 124, money-back guarantee (MBG) purchased (by a buyer) 126, MBG amount paid 128, transaction amount 130, and a transaction identification (ID) 132. The user type 124 indicates whether for the associated transaction, the user was a seller or a buyer. Since only a buyer can purchase a money-back guarantee, the MBG purchased 126 and MBG amount paid fields are only relevant to the buyer's record.

The money-back guarantee stats table 112 includes records that correspond to a buyer's historical selections relating to the money-back guarantee, which includes records indicating MBG offered 134, MBG option selected 136, number of reimbursement requests filed 138, and number of reimbursement requests paid 140.

The case management table 114 includes records that indicate the result of a reimbursement request generated by a user and more specifically, a buyer. These records include date of request for reimbursement 142, reimbursement decision 144, reimbursement amount 146, reimbursement date 148, and comments/notes 150. The reimbursement decision 144 can be based on such decisions as type of item, item's condition before and after buyer's possession, and time from transaction to requesting reimbursement. In one embodiment, the reimbursement amount 146 will correspond with a predetermined amount associated with the transaction cost less any fees corresponding to the purchase of the money-back guarantee.

In varying embodiments of the present invention, all the tables and associated databases described above in reference to the network-based marketplace machine 14 and the payment machine 16 can be separate, shared, linked or otherwise identical for the purpose of executing the system and method described herein. For example, the user table 108 of on database 52 of payment machine 16 may be separate, shared, linked or otherwise identical to user table 78 on database 37 of the network-based marketplace machine 14.

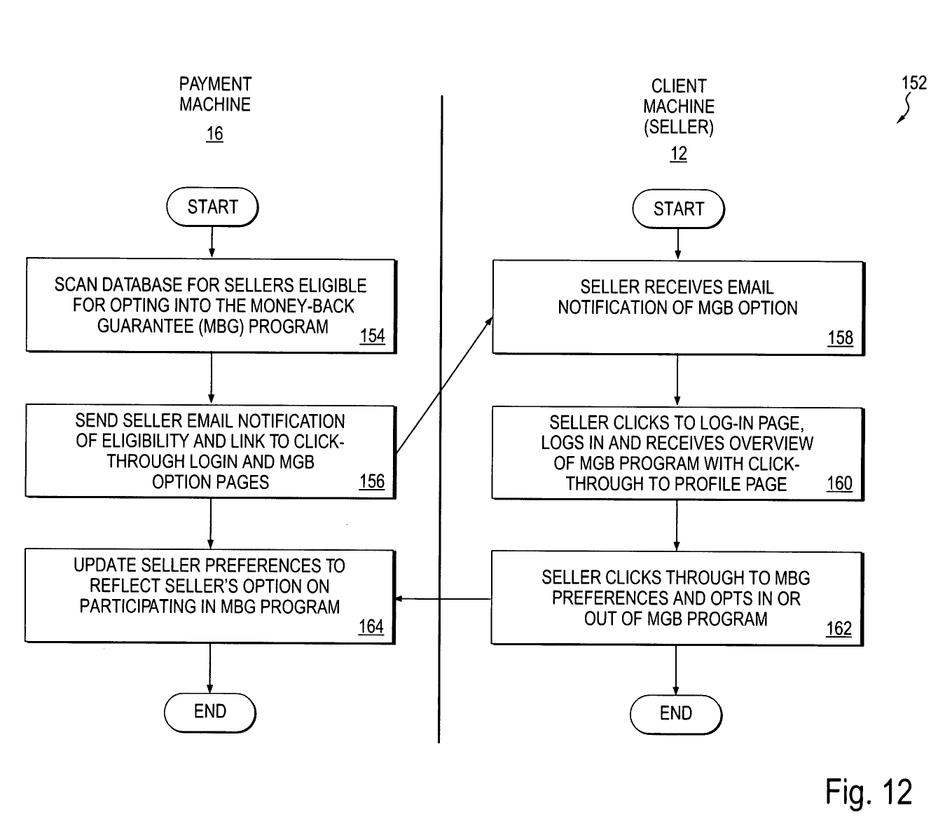

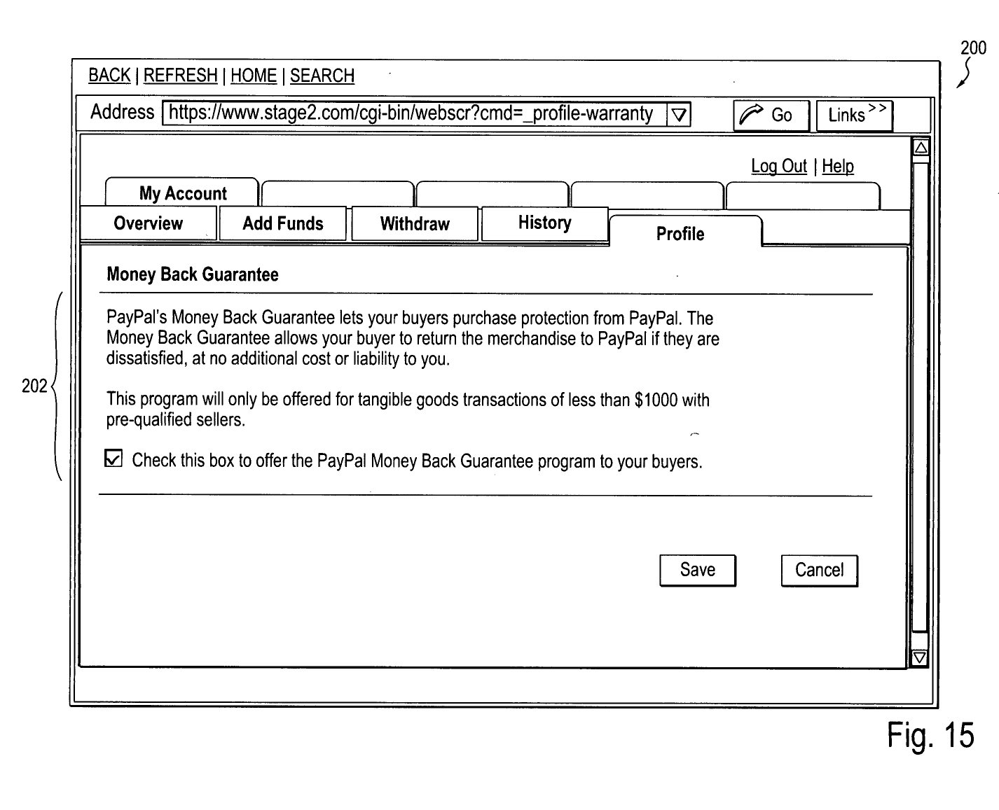

FIG. 12 is a flowchart illustrating a method 152, according to an exemplary embodiment of the present invention, wherein a payment machine 16 offers a seller on a client machine 12 the option to opt in or out of the money-back guarantee program. The payment machine 16 scans database 52, including user table 108, for sellers eligible for opting into the money-back guarantee program. In another embodiment, the payment machine 16 can access database 37 of the network-based marketplace machine 14 and can offer the seller the option of participating in the money-back guarantee program. In other embodiments, a sellers rating based on previous transactions and/or the seller's total number of transactions on the network-based marketplace machine 14 or the payment reputation on the payment machine 16 can be factors that determine a seller's eligibility to participate in the money-back guarantee program. Once it is determined that a seller is eligible, the payment machine 16, at box 156, sends the seller an email notification of eligibility and a link for a seller to click and login and access the money-back guarantee option pages. At box 158, the seller receives the email notification of the money-back guarantee option and, at box 160, the seller clicks through to the login page, logs in, and receives an overview of the money-back guarantee program and a link to the seller's profile page. Once at the profile page, the seller clicks through to the money-back guarantee preferences and, at box 162, opts in or out of the money-back guarantee program. FIG. 15 illustrates, according to an exemplary embodiment of the present invention, the opt in page 200 that includes the text 202 that further details the money-back guarantee program and supplies a check box for the seller to opt in to the money-back guarantee program. At box 164, the payment machine 16 updates the database 52 to reflect the seller's choice to opt in or opt out of the money-back guarantee program. In another embodiment of the present invention, the payment machine 16 also signals the network-based marketplace machine 14 to update its database 37 to reflect the seller's choice to opt in or opt out of the money-back guarantee program.

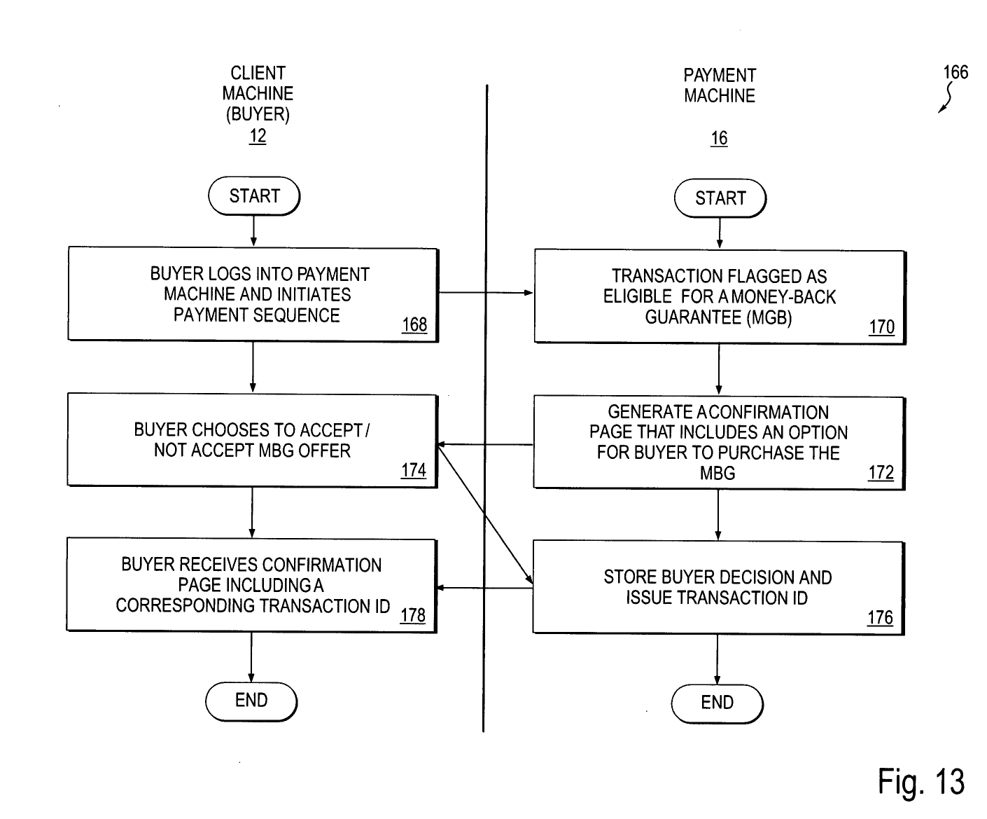

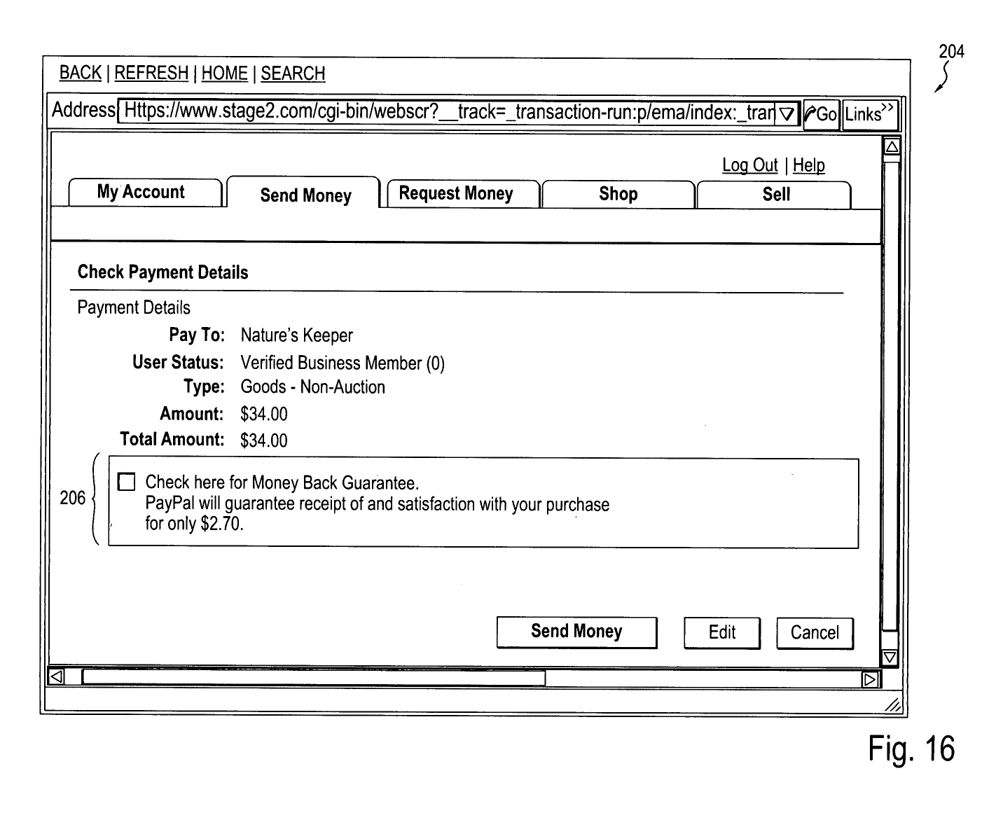

FIG. 13 is an interactive flowchart illustrating a method 166, according to an exemplary embodiment of the present invention, wherein a buyer on client machine 12 is offered by the payment machine 16 the option to purchase the money-back guarantee for the item being purchased. At box 168, buyer logs into payment machine and initiates payment sequence. The payment machine 16 at box 170 flags the transaction as being eligible for a money-back guarantee. At box 172, the payment machine 16 generates a payment confirmation page that includes an option for the buyer to purchase the money-back guarantee. The buyer then chooses to accept or not accept the money-back guarantee at box 174 and, at box 176, payment machine 16 stores the buyer's decision in database 52 and sends the buyer a confirmation page that includes the amount of the transaction and the transaction ID. At box 178, the buyer receives the confirmation page including the corresponding transaction ID. FIG. 16 is an example, according to an exemplary embodiment of the present invention, of a transaction confirmation page including an option to purchase the money-back guarantee. Specifically, text and check box 206 illustrates, according to an exemplary embodiment of the present invention, a description of the money-back guarantee and how the money-back guarantee is selected via the check box.

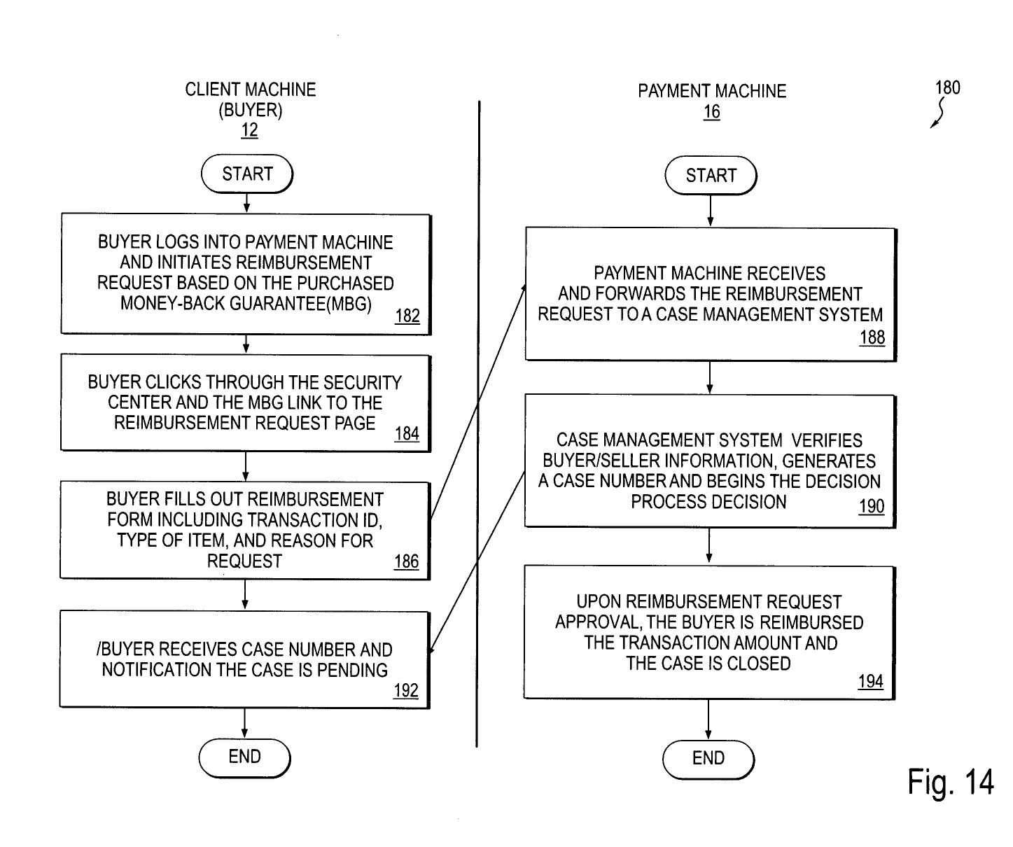

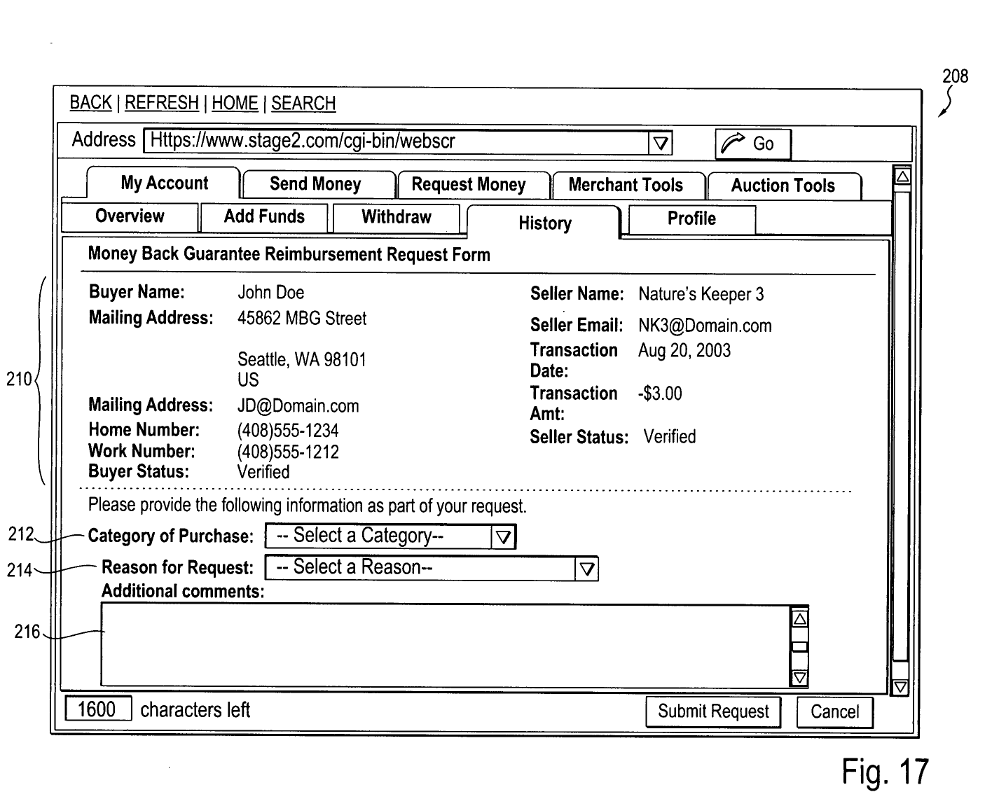

FIG. 14 is an interactive flowchart illustrating a method 180, according to an exemplary embodiment of the present invention, wherein a buyer at a client machine 12 initiates a reimbursement request for a transaction at payment machine 16. At box 182, the buyer logs into the payment machine 16 and, at box 184, clicks through to the security center to the money-back guarantee link and finally to the file reimbursement request page. At box 186, the buyer fills out the reimbursement request form that includes buyer and seller data, and item data corresponding to the associated transaction. FIG. 17 illustrates, according to an exemplary embodiment of the present invention, a money-back guarantee reimbursement request form 208. The text 210 includes buyer information such as name, address, email, and a home and work telephone number. Text 210 also includes seller information such as, seller name, seller email, transaction date, and the transaction amount. In order to identify the category of purchase, a drop down menu is supplied called, “category purchase” 212. In one embodiment this menu can include the following categories: computer hardware/software, home/consumer electronics, jewelry, antiques and collectibles, entertainment related goods, or other tangible goods. Another drop down menu indicates the reason for the reimbursement request. The “reason for request” 214 can include, for example, reasons such as, non-receipt, defective or incorrect merchandise, or unwanted merchandise. Text box 216 allows for a buyer to enter in additional comments, for example, comments that pertain to the reimbursement request. At box 188, once the payment machine receives the reimbursement request, it forwards the request to a case management system. The case management system, at box 190, verifies the buyer and seller information, generates a case number, and begins the decision process. At box 192, the buyer receives the case number and a notification explaining the case is pending. If the reimbursement request is approved, at box 194, the buyer is reimbursed the transaction amount and the case is closed.

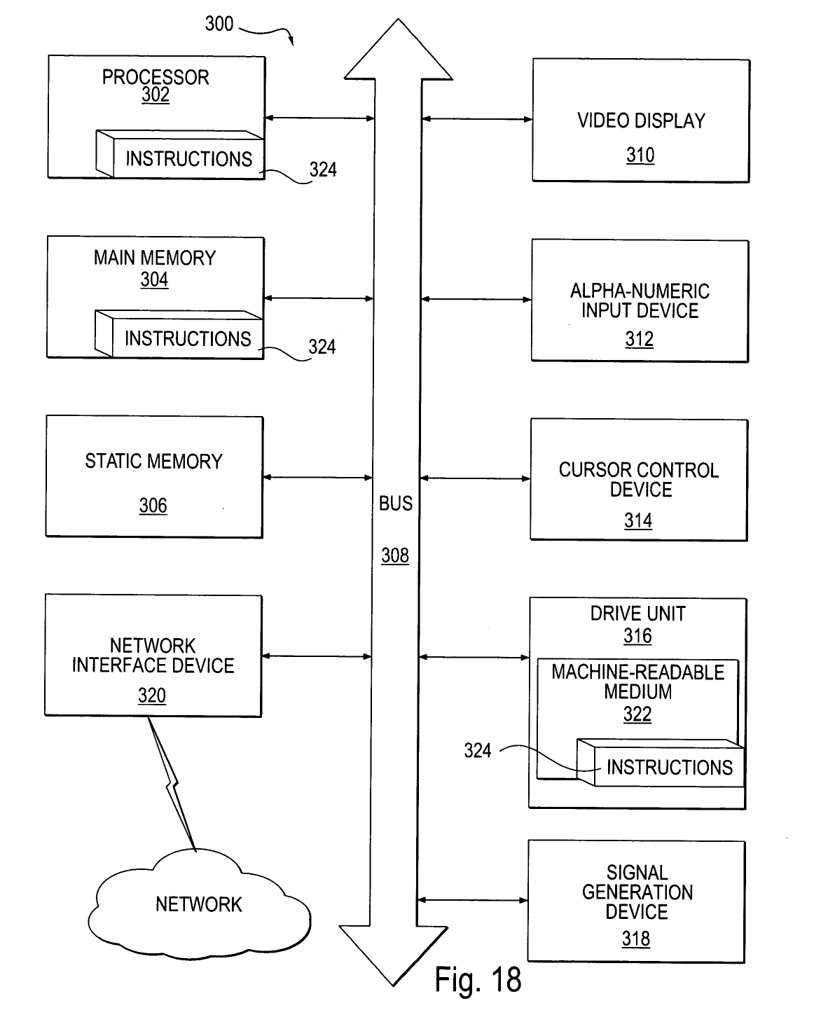

FIG. 18 illustrates a diagrammatic representation of machine in the exemplary form of a computer system 200 wherein a set of instructions can be executed to cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 200 includes a processor 202 (e.g., a central processing unit (CPU) a graphics processing unit (GPU) or both), a main memory 204 and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions (e.g., software 224) embodying any one or more of the methodologies or functions described herein. The software 224 may also reside, completely or at least partially, within the main memory 204 and/or within the processor 202 during execution thereof by the computer system 200, the main memory 204 and the processor 202 also constituting machine-readable media.

The software 224 may further be transmitted or received over a network 226 via the network interface device 220.

While the machine-readable medium 222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and system to provide a money-back guarantee for a transaction in a network-based marketplace have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method of providing a money-back guarantee for a transaction in a network-based marketplace, the method including:
receiving, over a network, a reimbursement request against the money-back guarantee for an eligible transaction;
responsive to receiving the reimbursement request, verifying the reimbursement request is eligible for the money-back guarantee; and
electronically reimbursing a buyer a predetermined amount associated with the eligible transaction and the money-back guarantee.

2. The method of claim 1, including determining if a seller is eligible to offer the buyer the money-back guarantee.

3. The method of claim 2, including offering the seller an option to offer the buyer the money-back guarantee if the seller is eligible.

4. The method of claim 3, including providing a seller interface for the seller to choose whether the money-back guarantee is offered on the eligible transaction.

5. The method of claim 1, including verifying that the eligible transaction is eligible for the money-back guarantee.

6. The method of claim 5, wherein the verifying includes determining that a transaction amount associated with the eligible transaction does not exceed a predetermined threshold.

7. The method of claim 5, wherein the verifying includes determining that a transaction occurred within a predetermined timeframe.

8. The method of claim 1, including providing a guarantee interface for the buyer to activate the money-back guarantee associated with the eligible transaction.

9. The method of claim 8, including collecting a fee from the buyer for activating the money-back guarantee, wherein the fee is in addition to the associated transaction cost.

10. The method of claim 9, including calculating the fee base upon a predetermined percentage of the transaction amount plus a flat fee.

11. The method of claim 9, including receiving payment from the buyer for the money-back guarantee and the associated transaction cost and responsive to receiving the payment, generating a transaction identification number.

12. The method of claim 1, including providing a reimbursement request interface for the buyer to submit the reimbursement request against the money-back guarantee associated with the eligible transaction.

13. The method of claim 1, wherein the reimbursement request includes a transaction number, date of transaction, reason for the request, and type of item associated with the request.

14. The method of claim 1, wherein the verifying of the reimbursement request includes verifying the eligibility of the transaction and seller for the money-back guarantee and verifying the buyer paid for the money-back guarantee.

15. The method of claim 1, including reimbursing the buyer if an item associated with the eligible transaction is alleged to be defective.

16. The method of claim 1, including reimbursing the buyer if an item associated with the eligible transaction is not received by the buyer.

17. The method of claim 1, including reimbursing the buyer if an item associated with the eligible transaction is unwanted.

18. The method of claim 1, wherein the eligible transaction is an online transaction using the Internet.

19. The method of claim 18, wherein the online transaction is associated with an online auction.

20. The method of claim 18, wherein the online transaction is a fixed price transaction.

21. The method of claim 1, wherein the network-based marketplace supports transactions between a plurality of sellers and a plurality of buyers.

22. A system to provide a money-back guarantee for a transaction in a network-based marketplace, the system including:
a reimbursement request module to receive, over a network, a reimbursement request against the money-back guarantee for an eligible transaction;
a reimbursement verification module, responsive to receiving the notification from the reimbursement request module, to verify the reimbursement request is eligible for the money-back guarantee; and
a disbursement module, responsive to receiving verification the reimbursement request is eligible, to electronically reimburse a buyer a predetermined amount associated with the eligible transaction and the money-back guarantee.

23. The system of claim 22, including a seller verification module to determine if a seller is eligible to offer a buyer the money-back guarantee.

24. The system of claim 23, including a seller interface module to offer the seller an option to offer buyers the money-back guarantee if the seller is eligible.

25. The system of claim 24, wherein the seller interface module is to provide a seller interface for the seller to choose whether the money-back guarantee is offered on all eligible transactions.

26. The system of claim 22, wherein the transaction verification module is to verify that the transaction is eligible based upon the transaction amount not exceeding a predetermined threshold.

27. The system of claim 22, wherein the transaction verification module is to verify the transaction is eligible based upon the transaction occurring within a predetermined timeframe.

28. The system of claim 22, including a buyer interface module to provide a guarantee interface for the buyer to activate the money-back guarantee associated with the eligible transaction.

29. The system of claim 28, including a transaction module to collect a fee from the buyer for activating the money-back guarantee, wherein the fee is in addition to the associated transaction cost.

30. The system of claim 29, wherein the transaction module is to calculate the fee base upon a predetermined percentage of the transaction amount plus a flat fee.

31. The system of claim 29, wherein the transaction module is to receive payment from the buyer for the money-back guarantee and the associated transaction cost and to generate a transaction number in response to receiving the payment.

32. The system of claim 22, including a buyer interface module to provide a reimbursement request interface for the buyer to select the money-back guarantee associated with the eligible transaction.

33. The system of claim 22, wherein the reimbursement request includes a transaction number, date of transaction, reason for the request, and type of item associated with the request.

34. The system of claim 22, wherein the reimbursement verification module is utilized to verify the reimbursement request is associated with the eligible transaction and the buyer paid a fee for the money-back guarantee.

35. The system of claim 22, wherein the reimbursement verification module is utilized to initiate reimbursement to the buyer if an item associated with the eligible transaction is defective.

36. The system of claim 22, wherein the reimbursement verification module is utilized to initiate reimbursement to the buyer if the buyer does not receive an item associated with the eligible transaction.

37. The system of claim 22, wherein the reimbursement verification module is utilized to initiate reimbursement to the buyer if an item associated with the eligible transaction is unwanted.

38. The system of claim 22, wherein the reimbursement request includes a transaction number, date of transaction, reason for the request, and type of item associated with the request.

39. The system of claim 22, wherein the eligible transaction is an online transaction using the Internet.

40. The system of claim 39, wherein the online transaction is associated with an online auction.

41. The system of claim 39, wherein the online transaction is a fixed price transaction.

42. A machine readable medium storing a set of instructions that, when executed by a machine, cause the machine to:
receive notification over a network indicating the reimbursement request;
responsive to receiving the notification, verify the reimbursement request is eligible for the money-back guarantee; and
electronically reimburse the buyer a predetermined amount associated with the eligible transaction and the money-back guarantee.

43. A system to discharge a liability owed to a buyer and stored in a first proprietary currency, the system including:
a first means for receiving notification over a network indicating the reimbursement request;
a second means for responding to receiving the notification, verifying the reimbursement request is eligible for the money-back guarantee; and
a third means for electronically reimbursing the buyer a predetermined amount associated with the eligible transaction and the money-back guarantee.
